(19) United States
(12) Patent Application Publication
(10) Pub. No.: US 2007/0086352 A1
(43) Pub. Date: Apr. 19, 2007

(54) Method of monitoring multimedia stream exchange session initialization messages and a server and an installation for carrying out said method

(75) Inventors: Stephane Tuffin, Louannec (FR); Sophie Aveline, Boulogne (FR); Kim-Anh-Vu Nguyen, Fontenay-Aux-Roses (FR)

Correspondence Address: OLIFF & BERRIDGE, PLC, P.O. BOX 19928, ALEXANDRIA, VA, 22320, US

(73) Assignee: France Telecom, Paris (FR)

(21) Appl. No.: 10/576,545

(22) PCT Filed: Oct. 20, 2004
(86) PCT No.: PCT/FR04/02680

§ 371 Date: Jul. 5, 2006

(51) Int. Cl. H04J 1/16

(52) U.S. Cl. 370/252; 370/401

(57) ABSTRACT

The invention relates to a method of monitoring multimedia stream exchange session initialization messages transmitted in packet mode via a monitoring server over a network between a sender terminal and one or more receiver terminals. Said method comprises a step (50) of estimating a bit rate value for at least one initialization packet received by the monitoring server, a step (52) of comparing said value to a maximum authorized bit rate value, and a step (40) of authorizing transmission of the initialization packet only if the bit rate value for said packet does not exceed the maximum authorized bit rate value. The estimated bit rate value is optionally an average value that is measured over a sliding time window. The invention also relates to a server and an installation for carrying out the method of the invention.

The present invention relates to a method of monitoring multimedia stream exchange session initialization messages and to a server and an installation for carrying out said method.

To be more precise, the invention relates to a method of monitoring multimedia stream exchange session initialization messages transmitted in packet mode via a monitoring server over a network between a sender terminal and one or more receiver terminals.

The term “initialization” refers to setting up, modifying or closing a session during which multimedia streams are exchanged.

The invention is described below with reference to the Session Initialization Protocol (SIP). The invention is not limited to that protocol alone, however.

The Session Initialization Protocol is a protocol of the Application layer of the OSI model and is used to set up, modify, and close a session during which multimedia streams are exchanged between a sender terminal and one or more receiver terminals.

It uses messages that circulate in the form of packets in an SIP network that is made up of dedicated processing servers. The SIP network and overlays an IP network. The path taken by the SIP messages is therefore not necessarily the same as that taken by the multimedia streams.

Session set-up consists in exchanging SIP messages to define the type and format of the multimedia streams that the terminals wish to exchange (for example the codecs used). SIP messages can be exchanged between the terminals during a session to agree a new multimedia stream format. Finally, SIP messages are again exchanged on closing a session.

The operator of the network over which the multimedia streams are exchanged generally bills the user of the terminal that sets up the connection as a function of the duration of the multimedia stream exchange session. The operator does not bill the user of the terminal if it does not succeed in setting up the connection, despite the exchange of SIP messages.

Now, because the operator generally does not verify the content of the SIP messages, it is possible for a malicious user to use the SIP messages themselves and the bandwidth assigned by the operator for their transmission to send data that is not related to setting up a connection, in particular the multimedia data itself.

The user can therefore exchange multimedia information over the network without being billed by the operator.

To overcome this problem SIP processor servers use methods known in the art to limit the transmission of SIP messages to messages containing only predefined information elements appropriate to the services that the network operator wishes to provide to its users.

However, the above method requires the SIP processing servers that compare each SIP message to the messages authorized by the operator to have a high processing capacity. It also necessitates updating of the SIP processing servers each time that the operator decides to modify the SIP message types for which transmission over its network is authorized. This solution is effective but complicated and costly to implement.

The object of the invention is to solve the above problems by providing a method of monitoring multimedia stream exchange session initialization messages capable of verifying that the session initialization messages are not being used to transmit information illicitly without verifying the content of each initialization message in transit in the network.

To this end, the invention consists in a method of monitoring multimedia stream exchange session initialization messages transmitted in packet mode via a monitoring server over a network between a sender terminal and one or more receiver terminals, characterized in that it comprises the following steps:

estimating a bit rate value for at least one initialization packet received by the monitoring server;

comparing that value to a maximum authorized bit rate value; and

authorizing transmission of the initialization packet only if the bit rate value for that initialization packet does not exceed the maximum authorized bit rate value.

By monitoring the bit rate of the SIP packets in transit in the network, the invention detects illicit SIP packets which, containing information of no use to the SIP protocol, abnormally increase the inherent packet bit rate. The transmission of such SIP packets is then interrupted.

A method of the invention of monitoring messages transmitted in packet mode may further have one or more of the following features:

a transmission channel associated with a specific maximum authorized bit rate value is defined for each pair comprising a sender terminal and a receiver terminal;

estimating the bit rate value for the initialization packet received by the monitoring server includes steps of storing the sizes of the latest initialization packets sent by the sender terminal to the receiver terminal and received by the monitoring server during a predetermined duration, and dividing the sum of the sizes of the stored initialization packets by the predetermined duration;

the method is implemented by the monitoring server, which also processes session initialization packets;

the session initialization packets are forcibly routed to the monitoring server consisting of the first processor server through which said session initialization packets pass;

the monitoring server consists of any of the session initialization packet processor servers and routing rules are defined to ensure that the session initialization packets systematically pass in transit through said processor server; and

the session initialization messages transmitted use the Session Initialization Protocol (SIP).

The invention also consists in a server for monitoring multimedia stream exchange session initialization messages transmitted in packet mode via a monitoring server over a network between a sender terminal one or more receiver terminals, characterized in that it includes:

means for estimating a bit rate value for at least one initialization packet received by the monitoring server;

means for comparing that value to a maximum authorized bit rate value; and

means for authorizing transmission of the initialization packet only if the bit rate value for that initialization packet does not exceed the maximum authorized bit rate value.

The invention further consists in an installation for transmitting multimedia stream exchange session initialization messages, including a network including one or more monitoring servers according to the invention.

The invention can be better understood on reading the following description, which is given by way of example only and with reference to the appended drawing, in which:

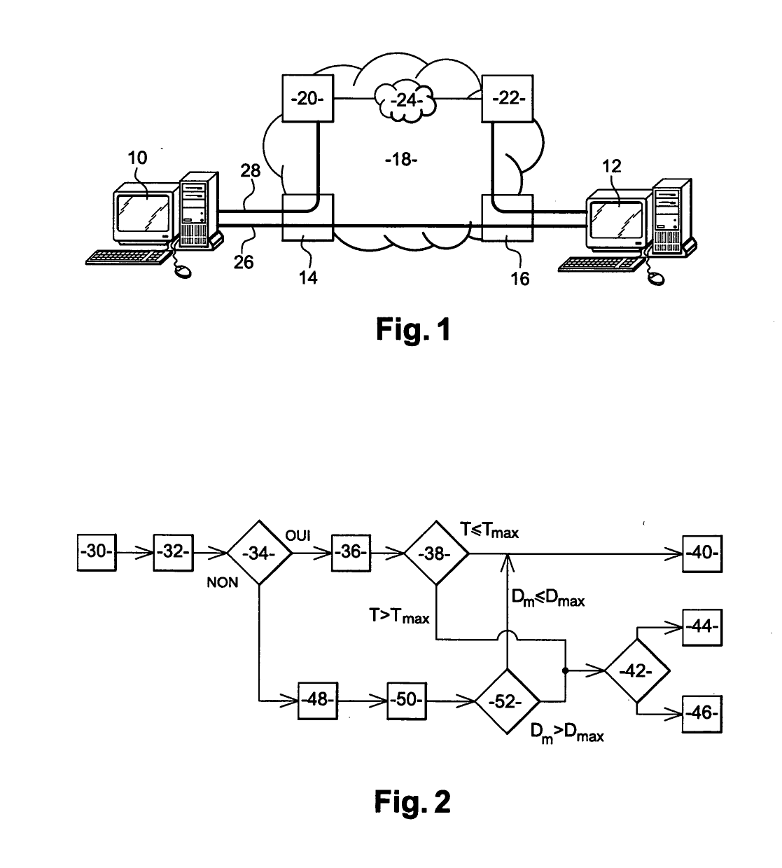

FIG. 1 is a diagram of an installation for implementing a method of the invention, and

FIG. 2 is a functional block diagram representing the successive steps of a method of the invention.

FIG. 1 shows a sender terminal 10 communicating with a receiver terminal 12 via a data transmission network 18.

The terminals 10 and 12 are computers or telephones, for example, and the data transmission network 18 is an IP network 18 or a switched telephone network combined with an IP network.

The data transmission network 18 includes a set of interconnected routers 14, 16 whose function is to route messages correctly across the data transmission network 18 between the terminals 10 and 12.

The terminals 10 and 12 exchange initialization messages for initializing multimedia stream exchange sessions and also exchange multimedia streams. The initialization messages considered in the remainder of the description are SIP messages.

These SIP messages are transmitted in packet mode, i.e. in the form of a plurality of packets.

The data transmission network further includes dedicated SIP packet processor servers 20, 22 that are interconnected to form a network 24 overlaying the data transmission network 18. The network 24 overlaying the transmission network 18 is referred to as the SIP network in the remainder of the description because it is dedicated to transferring SIP messages. The function of the SIP processor servers 20, 22 is to route SIP packets correctly across the SIP network 24 between the terminals 10 and 12.

When two terminals 10 and 12 wish to set up a connection to exchange a multimedia stream 26, they exchange an SIP stream 28 to define the type and format of the multimedia stream 26.

The multimedia and SIP streams generally take different network paths. The path taken by the multimedia streams 26 depends on the IP addresses of the computers 10, 12 and is determined by the IP routers 14, 16 of the network. The path taken by the SIP streams 28 may depend on the IP addresses of the computers 10, 12, but also on the telephone numbers or electronic mail addresses of the users of the computers 10, 12. It is determined by the SIP processor servers 20, 22 and necessarily passes in transit through the SIP network 24.

In the SIP network 24, the SIP streams 28 are transmitted over different SIP channels and can be identified by the addresses of the computers 10, 12 between which the streams are transmitted or the addresses (for example the telephone numbers) of the users of the computers 10 and 12.

The monitoring method of the invention is implemented by a monitoring server through which the SIP packets pass and which generally also processes the SIP packets.

The monitoring method of the invention is therefore implemented by one of the SIP processor servers 20, 22 and consists in monitoring the SIP messages transmitted in packet mode across the network 18 between the sender terminal 10 and the receiver terminal 12.

For a given SIP channel, a bit rate value Dm is estimated for a SIP packet sent over that channel and that bit rate value Dm is compared to a maximum authorized bit rate value Dmax. Transmission of the SIP packet is then authorized only if the bit rate value Dm for that SIP packet does not exceed the maximum authorized bit rate value Dmax.

The maximum authorized bit rate Dmax for a given SIP channel is defined beforehand and communicated by the operator to the SIP monitoring servers 20, 22 that implement the monitoring method. The operator also communicates the maximum authorized packet size Tmax. This data is useful for the SIP monitoring servers when a new SIP channel is created and the servers have not received sufficient SIP packets to be able to calculate the bit rate value Dm of the new packet sent over the new SIP channel created.

The values of the maximum authorized bit rate Dmax and the maximum authorized packet size Tmax depend on the SIP message channel, i.e. on the terminals exchanging the SIP messages. For example, certain users may need a higher maximum authorized SIP bit rate, in particular if they use encrypted data, as encryption increases the amount of data to be transmitted.

Not all the SIP processor servers of the network are necessarily SIP monitoring servers. It is therefore necessary to make sure that at least one of the SIP processor servers through which a SIP packet passes is a SIP monitoring server.

For example, the invention may be implemented by a single SIP surveillance server that is the first processor server through which the SIP packets pass. A software device such as a firewall may then be used in the routers 14, 16 to force the routing of the SIP packets to that first SIP processor server.

The invention may instead be implemented by an SIP monitoring server that is any of the SIP processor servers of the SIP network. Routing rules are then defined to ensure that the SIP packets pass systematically in transit through that SIP processor server.

The monitoring method represented in FIG. 2 includes a first step 30 in which the SIP monitoring server 20, 22 receives an SIP packet.

In the next step 32, the SIP monitoring server 20, 22 identifies the SIP channel relating to the received packet from the addresses of the sender and the receiver of the SIP packet received.

During the next step 34, which is a test step, the SIP monitoring server 20, 22 tests if the SIP packet received relates to a newly created SIP channel or to a SIP channel that is already in use.

If the SIP channel is newly created, the next step is a step 36 of creating a list called Latest_Packets_List which stores for each SIP channel the size and the time of reception of all the packets relating to that SIP channel received within a duration D predetermined by the operator. This Latest_Packets_List operates as a sliding time window: information relating to the latest packet received is inserted into the list and information relating to packets received before the duration D are removed from the list. The first packets to enter the list are also the first to leave.

During the next step 38, which is a test step, the SIP monitoring server verifies if the size T of the received packet is less than the maximum authorized packet size Tmax.

If the size T of the received packet is less than the maximum authorized size Tmax, the next step is a step 40 of the SIP monitoring server forwarding the received packet.

If not, the next step is a test step 42 during which the monitoring server tests if the received SIP packet corresponds to an SIP request or to an SIP response.

If the packet received corresponds to a request, the next step is a step 44 during which the SIP monitoring server 20, 22 eliminates the request instead of forwarding it to the addressee and sends an error response to the sender of the packet.

If the packet received corresponds to a response, the next step is a step 46 during which the SIP monitoring server does not forward the response to the addressee and sends a “cancellation” message to the addressee.

If, during the step 34, the monitoring server finds that the received packet corresponds to an SIP channel that is already in use, the next step is a step 48 of updating the Latest_Packets_List relating to the SIP channel of the received packet by adding to the list information concerning the latest packet received and removing from the list information concerning packets received before the storage duration D.

During the next step 50, the SIP monitoring server estimates the average bit rate Dm of the packets relating to the SIP channel of the latest packet received. That average bit rate is estimated by dividing the sum of the sizes of the packets stored in Latest_Packets_List by the storage duration D.

During the next step 52, which is a test step, the SIP monitoring server verifies if the average bit rate Dm is less than the maximum authorized bit rate Dmax.

If the average bit rate Dm is less than the maximum authorized bit rate Dmax, the next step is the step 40.

If the average bit rate DM is greater than the maximum authorized bit rate Dmax, the next step is the step 42.

1. A method of monitoring multimedia stream exchange session initialization messages transmitted in packet mode via a monitoring server (20, 22) over a network (18) between a sender terminal (10) and one or more receiver terminals (12), characterized in that it comprises the following steps:
estimating (50) a bit rate value for at least one initialization packet received by the monitoring server (20, 22);
comparing (52) that value to a maximum authorized bit rate value; and
authorizing (40) transmission of the initialization packet only if the bit rate value for that initialization packet does not exceed the maximum authorized bit rate value.

2. A method according to claim 1 of monitoring messages transmitted in packet mode, wherein a transmission channel associated with a specific maximum authorized bit rate value is defined for each pair comprising a sender terminal and a receiver terminal.

3. A method according to claim 1 of monitoring messages transmitted in packet mode, wherein estimating (50) the bit rate value for the initialization packet received by the monitoring server includes the following steps:
storing the sizes of the latest initialization packets sent by the sender terminal (10) to the receiver terminal (12) and received by the monitoring server (20, 22) during a predetermined duration; and
dividing the sum of the sizes of the stored initialization packets by the predetermined duration.

4. A method according to claim 1 of monitoring messages transmitted in packet mode, implemented by the monitoring server (20, 22), which also processes session initialization packets.

5. A method according to claim 4 of monitoring messages, wherein the session initialization packets are forcibly routed to the monitoring server (20, 22) consisting of the first processor server through which said session initialization packets pass.

6. A method according to claim 4 of monitoring messages, wherein the monitoring server (20, 22) consists of any of the session initialization packet processor servers and routing rules are defined to ensure that the session initialization packets systematically pass in transit through said processor server.

7. A method according to claim 1 of monitoring messages transmitted in packet mode, wherein the session initialization messages transmitted use the Session Initialization Protocol (SIP).

8. A server (20, 22) for monitoring multimedia stream exchange session initialization messages transmitted in packet mode via a monitoring server over a network (18) between a sender terminal (10) and one or more receiver terminals (12), characterized in that it includes:
means for estimating (50) a bit rate value for at least one initialization packet received by the monitoring server (20, 22);
means for comparing (52) that value to a maximum authorized bit rate value; and
means for authorizing (40) transmission of the initialization packet only if the bit rate value for that initialization packet does not exceed the maximum authorized bit rate value.

9. An installation for transmitting multimedia stream exchange session initialization messages, including a network (18) including one or more monitoring servers (20, 22) according to claim 8.

10. A method according to claim 2 of monitoring messages transmitted in packet mode, wherein estimating (50) the bit rate value for the initialization packet received by the monitoring server includes the following steps:
storing the sizes of the latest initialization packets sent by the sender terminal (10) to the receiver terminal (12) and received by the monitoring server (20, 22) during a predetermined duration; and
dividing the sum of the sizes of the stored initialization packets by the predetermined duration.

11. A method according to claim 2 of monitoring messages transmitted in packet mode, implemented by the monitoring server (20, 22), which also processes session initialization packets.

12. A method according to claim 3 of monitoring messages transmitted in packet mode, implemented by the monitoring server (20, 22), which also processes session initialization packets.

13. A method according to claim 2 of monitoring messages transmitted in packet mode, wherein the session initialization messages transmitted use the Session Initialization Protocol (SIP).

14. A method according to claim 3 of monitoring messages transmitted in packet mode, wherein the session initialization messages transmitted use the Session Initialization Protocol (SIP).

15. A method according to claim 4 of monitoring messages transmitted in packet mode, wherein the session initialization messages transmitted use the Session Initialization Protocol (SIP).

16. A method according to claim 5 of monitoring messages transmitted in packet mode, wherein the session initialization messages transmitted use the Session Initialization Protocol (SIP).

17. A method according to claim 6 of monitoring messages transmitted in packet mode, wherein the session initialization messages transmitted use the Session Initialization Protocol (SIP).
